(19) United States
(12) Patent Application Publication
(10) Pub. No.: US 2003/0070555 A1
(43) Pub. Date: Apr. 17, 2003

(54) Coffee brewing apparatus

(76) Inventor: Shahryar Reyhanloo, Lohn Ammannsegg (CH)

Correspondence Address: VENABLE, BAETJER, HOWARD AND CIVILETTI, LLP, P.O. BOX 34385, WASHINGTON, DC, 20043-9998, US

(21) Appl. No.: 10/270,308

(22) Filed: Oct. 15, 2002

(30) Foreign Application Priority Data
Oct. 15, 2001 (CH) CH 1892/01

(51) Int. Cl. A23F 3/00

(52) U.S. Cl. 99/282; 222/54

(57) ABSTRACT

A coffee brewing apparatus has a brewing device in which coffee powder is brewed in a brewing process with pressurised hot water. Parameters of the brewing procedure are adjustable with a control unit of the coffee brewing apparatus. The control unit includes an electronic interface via which the information related to the coffee brewing machine can be exchanged in the form of signals, wherein a transportable electronic storage medium may be attached to the interface, and may be connected to an external control unit. The external control unit is a personal computer (PC), and a docking station is provided that may be attached to the personal computer, into which docking station the transportable electronic storage medium may be inserted for the purpose of data exchange. Advantages of the device include the fact that a coffee machine may be provided with the most recent information and functionalities even after its installation without great technical effort, and service information can be transmitted to a servicing centre via the Internet.

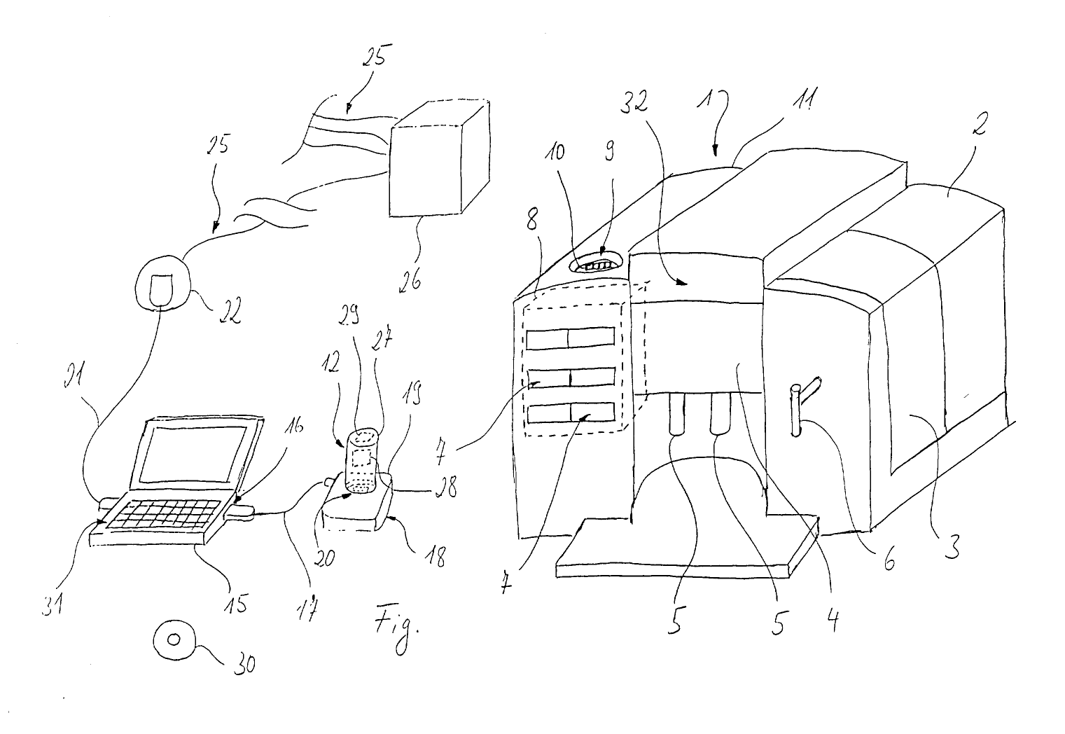

The invention relates to a coffee brewing apparatus for preparing coffee, including a brewing device, in which a coffee powder may be brewed in hot water, wherein parameters of the brewing procedure are adjustable with a control unit of the apparatus. The invention further relates to a coffee brewing system that incorporates several coffee brewing apparatuses and a central information point for effecting communication with the coffee brewing apparatuses. Finally, the invention also relates to a method according to the preamble of claim 12 and a software product according to the preamble of claim 15.

Coffee brewing apparatuses as such, in particular automatic coffee brewing apparatuses, have been known for a long time. In coffee brewing apparatuses of such kind, a user may usually select a type of coffee, such as a small espresso, a large espresso, or a standard coffee via a keypad or other operation elements arranged on the device housing, and then instruct the machine to brew the coffee. Automatic coffee brewing apparatuses have also been introduced with which the user first modifies default brewing parameters via the keypad and may then store permanently these changed parameters in a storage unit of the coffee brewing machine.

Other coffee brewing machines have also been introduced that may be connected via a serial port to a diagnostic device arranged immediately adjacent to the coffee brewing machine in question. The diagnostic device may then read out information that is stored in the coffee brewing machine regarding the status of the machine. For this purpose, however, the coffee brewing machine must be taken to a dealer or the manufacturer of the coffee brewing machine, who possess such a diagnostic device.

European Patent No. EP-0 586 330 discloses a machine for dispensing beverages and a series of several machines connected to one beverage dispensing arrangement. The machines are equipped with an interface for the insertion of a chipcard as a transportable electronic storage medium. The chipcards are used for two-way data communication with a chipcard processing device. The chipcards may contain data for controlling and/or parameterising the beverage preparation machines. The chipcards serve as a key for dispensing beverages and as a means for help in the method of payment for dispensed beverages. The chipcard processing device is a specialised unit designed to manage these operations centrally. The chipcards may be inserted either directly into the corresponding interfaces of the beverage dispensing machines or in the corresponding interface of the chipcard processing device. While this solution enables simple, localised exchange of data, it is not suitable for universal and widely dispersed use. In addition, it still requires a specialised local device in the form of a chipcard processing device.

It is therefore the object of the present invention to further simplify the exchange of data with the coffee brewing machine, particularly of data that formerly needed to be entered manually by the user.

The object is solved according to the invention in a coffee brewing machine of the type described in the introduction by an electronic interface that allows the exchange of information related to the coffee brewing machine in the form of signals, wherein a transportable electronic storage medium may be attached to the interface, and may be connected to an external control unit, which external control unit is a personal computer (PC), and a docking station is provided that may be attached to the personal computer, into which docking station the transportable electronic storage medium may be inserted for the purpose of data exchange. The object is further solved by a coffee brewing system and a process as well as a software product as described in claims 6, 11 and 14.

The configuration of the interface and the transportable electronic storage medium for use with a docking station that may be attached to a normal personal computer has the advantage that standard commercially available devices—and in many locations personal computers that are already in place—may be used.

Unlike the known coffee machines, this device enables the user for the first time to load the coffee machine with the most recent information and functionalities even after installation without great technical effort. This capability was not available previously. Hitherto, if such data exchange were even possible, the coffee machine would have had to be moved, or a service technician would have had to travel to the location of the coffee device to make the modifications. Although none of the these actions is required, the idea on which the invention is based makes it possible for the coffee machine to be supplied with, for example, most recent advances in brewing parameters, such as (sub)combinations of the water quantity, water temperature, water pressure, powder quantity and grinding level of the powder. In conjunction with the type of coffee used, these parameters are principally responsible for the aroma of the coffee. In accordance with the invention, it is thus possible to provide that the user may obtain aromas provided by the manufacturer of the machine via the Internet from a shipping location independently and without recourse to a service technician. The user is thus able to enter the parameters for individual aromas into the coffee machine and store them there particularly easily.

A particularly significant benefit may be drawn from the idea underlying the invention if diagnostic information about the coffee machine can be exchanged between the user—or the coffee machine—and a central location, such as a server maintained by the manufacturer of the coffee machine. In this way, a central location that is responsible for repairs may be provided with machine data from a defective machine. By referring to the machine data that has been recorded constantly during operation up to that point, it may be determined, for instance, whether a real defect exists or whether the fault has been caused by incorrect operation. The customer may then be provided with the pertinent information, also remotely.

The device further offers the capability to fundamentally change the logistics of coffee machine servicing. Everything that is necessary for the repair of the machine may be initiated in a targeted manner on the basis of the diagnostic data. Since the nature of the defect is known, the corresponding replacement parts may be shipped immediately and a field technician with appropriate instructions may be sent to the location of the machine. Alternatively, the customer might be informed of the address of the nearest repair centre, and the repair centre might receive notification of the defect and a substantive repair order. This may serve to reduce significantly the time between detection and elimination of the defect.

Thus it is not only possible to economise on the transport costs that have hitherto been usual. It is also possible to eliminate a considerable portion of the costs previously accruing to many dealers associated with the diagnosis of the machine fault. If a coffee machine is defective, machine data regarding the coffee machine may be transmitted via data circuits by the user of the coffee machine himself for evaluation by a single, central diagnostic location, maintained, for example, by the manufacturer or a regional repair facility.

In a preferred embodiment, a modular configuration may be provided with regard to the capability of communicating data. This would mean that in its basic configuration, the coffee machine includes only an interface for data exchange. The requisite communication means, such as modem and data circuits, but also the corresponding storage media and software for the data exchange, are separate from the machine and are available as an upgrade. Since many households and almost all business premises have access to the Internet via a personal computer, this may also be used for the exchange of data according to the invention. In such case, it may be provided, for example, that a program be installed on the personal computer, which allows data communication in both directions, between the coffee machine and a centralised, remote computer to be assigned to the manufacturer. Of course, the data flow may also be wireless, for example via mobile telephones, radio and/or infrared radiation. This applies especially to the segment between the personal computer and the coffee machine.

In a particularly advantageous embodiment, a transportable storage module may be provided for this purpose, with which data may be read in and out both at the personal computer and on the coffee machine. The storage module should be equipped with a port for this purpose, with which it may be connected to the corresponding ports on the coffee machine and the personal computer. Particularly for the connection to the personal computer, this may be effected quite simply with a “docking station”, such as are known for example from portable personal computers and “organizers” (minicomputers) in a different field.

Further preferred configurations of the invention will become apparent from the dependent claims.

The invention will be explained in detail with reference to the embodiment represented diagramatically in the drawing.

The drawing shows a schematic configuration of a coffee brewing system according to the invention.

In the drawing, a preferred embodiment of the invention is shown that allows exchange of data with a coffee machine 1 in accordance with the invention. In this context, coffee machine 1 may be constructed with respect to all components associated with brewing coffee in the same way as known coffee machines.

The coffee machine 1 represented thus includes a storage receptacle 2 for coffee beans, which leads to grinding means (not further shown). The grinding means grinds the beans to a powder having an adjustable degree of fineness. Coffee machine 1 further includes a water reservoir 3 and a brewing device 4, the outflows 5 of both of which project from the front of the machine. In order to make the coffee, a predetermined quantity of hot water is forced in known manner under high pressure through a predetermined quantity of coffee powder in brewing device 4.

A foaming nozzle 6 is also provided, with which milk is foamed and hot water may also be supplied. Coffee machine 1 may be operated and various functions selected via a number of keys 7, also located on the front of the machine. Keys 7 form part of an electronic control unit 8 (indicated in outline only in the drawing) for coffee machine 1. Control unit 8 of this coffee machine according to the invention essentially also includes a processor, a volatile and a nonvolatile memory, in which the underlying control software for the coffee machine functions may be stored.

An interface 9 with the control unit in the form of electrical contacts 10 is located on a top side of the machine. In addition, interface 9 is equipped with an interface card which is located in housing 11, and which serves to process the signals passing through interface 9. The interface is provided to accommodate a mobile storage module 12 of the coffee machine that will be explained in greater detail in the following.

The drawing further shows a personal computer 15 in the form of a standard, commercially available notebook. A docking station 18 is connected to a port 16, for example a USB port of the notebook, via a data cable 17. The docking station is furnished with a housing 19 having a port 20. Port 20 of docking station 18 matches interface 9 of the coffee machine, including the interface card the principle of which is already known. In addition, docking station 18 is connected to a power supply (not further shown).

Notebook 15 is in turn connected via a modem and a data cable 21 to a telephone socket 22 in a building where coffee machine 1 is also located. Telephone socket 22 leads to the world-wide telephone and data transmission network 25, which is also used for Internet data communication. In another, distant building, which may be located for example in another city or another country, a server 26 is also connected to the telephone and data transmission network 25. Various information is available on the server in the form of programs and data. In this case, server 26 is configured and connected so that it may communicate with multiple calling devices such as computers simultaneously. The drawing does not show the various possible intermediate locations that are necessary for communication via the Internet.

Storage module 12 is furnished with a housing 27, in which a volatile memory 28—indicated by a broken line—is located, and to which and from which binary data can be written or read. The data may be retained in memory 28 via a rechargeable supply source 29 which is also located in the memory and also indicated by a broken line. Memory module 12 may also contain a processor that receives coordination tasks from functions to be executed by the memory module.

On computer 15, a program has been installed starting from a data carrier 30 and which assures the exchange of data according to the invention between the personal computer 15 or the server 26 respectively and the coffee machine 1. For this purpose, the program includes a graphical user interface that is displayed on the screen of the notebook, and which the user may use to select and/or configure various functions to be executed by the program. The program is further provided with (software) interface to allow data to flow to and from server 26. Additionally, the software includes another (software) interface, which is provided for data flow to and from storage module 12, which is located for this purpose in docking station 18.

When a connection has been established with the server, the user may retrieve information from server 26. In this case, data containing information about parameters to be set by control unit 8 on coffee machine 1 to influence the coffee aroma may flow from server 26 to personal computer 15 and then to storage module 12. This may be combinations of specific values relating to quantity, temperature and pressure of the water, quantity of powder and grinding fineness of the coffee powder.

However, it is also possible to enter data into the storage module via a keyboard 31 of computer 15. This may be, for example, a character string (text) that is to be appear in a display 32 of the coffee machine.

As soon as this data is written to storage module 12, storage module 12 may be removed from docking station 18, taken to coffee machine 1 and attached to interface 9 thereof. If the storage module is then inserted in the coffee machine, the data is read from storage module 12 and stored in the memory of control unit 8. The storage module has received and stored a corresponding command to this effect via the program on the personal computer. Thus control unit 8 receives new parameter combinations for selection, which the user may select with keys 7 and use in preparing the coffee.

On the other hand, data regarding the status of coffee machine 1 may also be written to the storage medium of the storage module. This data is gathered by the control unit as the coffee machine is being operated, and stored in its memory. This data too is copied to the storage module as soon as the module is connected to the interface on the coffee machine. When storage module 12 is subsequently inserted in docking station 18, it is then possible to read the data from the storage module with personal computer 15 and transmit it in the form of an electronic message to server 26 that is maintained by the manufacturer of the coffee machine.

It may be provided that the user himself may view at least a portion of the data on his personal computer 15. This may include, for example, statistical data, the number of portions of individual coffee types that have been prepared in a given time period, when the machine was last decalcified, etc. Other data, particularly such data that the user is not in a position to evaluate, should not be visible to the user. This data should only be available to the manufacturer.

The technical information is then evaluated and checked for deviations from setpoint values and/or reference states by the manufacturer or other central servicing location. Such deviations may then serve as the basis for determining the nature of the fault, and the manner in which it may be eliminated. It is also possible to provide the coffee machine user—also in the form of an electronic message—with the information he needs to rectify the fault.

If the user is not in a position to rectify the fault himself, the technical department of the machine's manufacturer may be notified. Since the cause of the fault is known, replacement parts may be shipped immediately and a service technician may be formally instructed to repair the machine.

Of course other information may also be transmitted to any coffee machine user via the data lines. Thus, for example, it is also possible to distribute updates to the machine control software for loading into the coffee machine. Additions to the operating instructions and servicing information, for example, may also be communicated, so that they are then available to the user with the program loaded on personal computer 15.

Finally, it may also be provided that the docking station is partly or completely integrated in the personal or notebook computer. For example, the interface may be configured such that a USB flash memory or similar storage medium is provided for direct connection via a USB port of a PC. Adapters may also be provided for this purpose.

1. A coffee brewing apparatus for preparing coffee, including a brewing device, in which coffee powder may be brewed with pressurised hot water in a brewing process, wherein parameters of the brewing procedure are adjustable with a control unit of the coffee brewing apparatus, an electronic interface with the control unit is provided, via which information related to the coffee brewing apparatus may be exchanged in the form of signals, wherein a transportable electronic storage medium that may be plugged into an external control unit is connectable to the interface,
characterised in that
the external control unit is a personal computer (PC) and a plug-in device (docking station) that may be connected to the personal computer is provided, to which the transportable electronic storage medium may be connected for purposes of data exchange.

2. The coffee brewing apparatus according to claim 1,
characterised in that
data received via the interface can be stored in a non-volatile memory of the control unit.

3. The coffee brewing apparatus according to either of the preceding claims,
characterised in that
diagnostic data regarding the coffee brewing apparatus may be exchanged with the control unit via the interface.

4. The coffee brewing apparatus according to any of the preceding claims,
characterised in that
data regarding the brewing procedure may be read into the control unit via the interface.

5. The coffee brewing apparatus according to any of the preceding claims,
characterised in that
the plug-in device is partly or completely integrated in the personal computer.

6. A coffee brewing system including a centralised information location and multiple, geographically distant coffee brewing apparatuses according to claim 1, wherein in each of the coffee brewing apparatuses coffee powder may be brewed with pressurised hot water in a brewing process, and wherein a transportable electronic storage medium may be connected to an interface on each of the coffee brewing apparatuses, the centralised information location is located externally to the coffee brewing apparatuses, the information location is provided for purposes of data exchange in the form of signals with each of the coffee brewing apparatuses, and the data exchange media use the Internet for exchanging data.

7. The coffee brewing system according to claim 6,
characterised in that
the information location is a server assigned to the manufacturer of the coffee brewing apparatus, which can be connected to the coffee brewing apparatus via technical data exchange media.

8. The coffee brewing system according to claim 7,
characterised in that
the server contains retrievable data, with which the aroma of a coffee prepared using the coffee brewing apparatus may be influenced.

9. The coffee brewing system according to either of claims 7 or 8,
characterised in that
the server is capable of exchanging data simultaneously with multiple coffee brewing apparatuses.

10. The coffee brewing system according to any of claims 6 to 9,
characterised in that
information regarding the status of a coffee brewing apparatus may be stored in electronic form in the transportable storage medium and may be transmitted to the information location.

11. A method for inputting/outputting data between a coffee brewing apparatus according to claim 1 and an information location located externally to the coffee brewing apparatus, in which data for the coffee brewing apparatus may be stored,
characterised by an
exchange of data in at least one direction between the coffee brewing apparatus and the information location, wherein data is transmitted by means of a telecommunication medium.

12. The method according to claim 11,
characterised in that
the data from a control unit in a brewing device of a coffee brewing apparatus is adjustable parameter values that can be used to influence the aroma of the coffee.

13. The method according to claim 12,
characterised in that
data relating to the properties of the coffee brewing apparatus is transmitted from a coffee brewing apparatus to the information location.

14. A software product that may be stored on a data carrier and is provided for exchange of data with a coffee brewing apparatus according to claim 1, and which includes a graphical interface for display on a computer viewing device, via which graphical interface configurations for data communication via the Internet can be made, wherein the software product may be used to send data relating to defined or adjustable parameters on a coffee brewing apparatus.

15. The software product according to claim 14,
characterised in that
the software product may be used to receive data regarding adjustable parameters from a sending location and transfer it to a memory in the coffee brewing apparatus, the aroma of the coffee being susceptible to modification with such data. 16. The software product according to either of claims 14 or 15,
characterised in that
the software product may be used to read data from a memory in the coffee machine and transmit such data via telecommunication means.
